(19) United States
(12) Patent Application Publication
(10) Pub. No.: US 2025/0358203 A1
(43) Pub. Date: Nov. 20, 2025

(54) DATA PLANE REDUNDANCY MANAGEMENT WITH INTELLIGENT LINECARD

(71) Applicant: Cisco Technology, Inc., San Jose, CA (US)

(72) Inventors: Dinuraj K, Bangalore (IN); Atri Indiresan, Sunnyvale, CA (US); Anand Sridharan, San Jose, CA (US); Saurabh Jain, Fremont, CA (US)

(21) Appl. No.: 18/665,340

(22) Filed: May 15, 2024

(51) Int. Cl. H04L 43/062; H04L 41/0663; H04L 43/022

(52) U.S. Cl. CPC H04L 43/062; H04L 41/0663; H04L 43/022

(57) ABSTRACT

Devices, systems, methods, and processes for data plane redundancy management in network devices are described herein. A linecard in a network device may classify a plurality of packets into a first category or a second category based on whether a packet is a control packet or a data packet. The linecard may transmit all control packets and data packets to an active data plane. The linecard may selectively transmit the control packets and a sampled subset of the data packets to a standby data plane. Thus, the standby data plane is equipped with dynamic information of network using the control packets and Media Access Control addresses using the sampled subset of the data packets. When a failure is detected in the active data plane, the linecard starts transmitting all the data packets also to the standby data plane and starts accepting processed packets from the standby data plane for forwarding.

The present disclosure relates to the field of networking. More particularly, the present disclosure relates to data plane redundancy management.

### BACKGROUND

Modern communication networks generally incorporate redundancy to ensure high network availability and reliability. This redundancy is often incorporated by connecting multiple redundant network components, for example, switches, routers, etc. Such redundancy helps in minimizing a downtime of a communication network and maintaining network connectivity in events of hardware failures or maintenance activities.

To provide resiliency in networks, network devices (e.g., routers and switches) may have redundancy built into them by incorporating a data plane redundant (DPR) system. In high-availability networks, a DPR system may include data planes configured as an active data plane and a standby data plane, for example. In general, the standby data plane is kept ready or otherwise available in a hot standby state to take over forwarding functions in case of a failure in the active data plane. Ideally, the hot standby data plane comes into action very quickly (for example, in the order of a few milliseconds) after a failure is detected in the active data plane.

In general, the standby data plane is continuously synchronized, so that in the event of a failure in the active data plane, the standby data plane is ready to take over the operation immediately without any noticeable interruption in service. This configuration provides a highly available system with minimal disruption to control and data plane functions.

### SUMMARY OF THE DISCLOSURE

Systems and methods for data plane redundancy management in accordance with embodiments of the disclosure are described herein. In some embodiments, a device includes a processor, a network interface controller configured to provide access to a network, and a memory communicatively coupled to the processor, wherein the memory includes a redundancy management logic that is configured to classify a plurality of packets into at least a first category or a second category, transmit a first set of packets of the classified plurality of packets to a first data plane and a second data plane, sample a second set of packets of the classified plurality of packets based on a sampling rate, and transmit the second set of packets to the first data plane and the sampled second set of packets to the second data plane.

In some embodiments, the first set of packets is classified into the first category.

In some embodiments, the first set of packets is classified into the first category in response to a determination that the first set of packets are control packets.

In some embodiments, the second set of packets is classified into the second category.

In some embodiments, the second set of packets is classified into the second category in response to a determination that the second set of packets are data packets.

In some embodiments, the plurality of packets are packets received by the device.

In some embodiments, the plurality of packets is associated with a traffic stream.

In some embodiments, the first data plane is an active data plane, and the second data plane is a standby data plane.

In some embodiments, a dynamic state of an Operations, Administration, and Maintenance (OAM) protocol is maintained in the second data plane based on the first set of packets.

In some embodiments, at least one packet of the plurality of packets is classified into one of the first category or the second category based on at least one of an Internet Protocol precedence value, differentiated services code point (DSCP) value, or a class of service (CoS) value associated with the packet.

In some embodiments, at least one packet of the plurality of packets is classified into one of the first category or the second category based on a Media Access Control (MAC) address associated with the at least one packet.

In some embodiments, to transmit the first set of packets to the second data plane, the redundancy management logic is further configured to replicate the first set of packets of the classified plurality of packets and transmit the replicated first set of packets to the second data plane.

In some embodiments, to sample the second set of packets, the redundancy management logic is further configured to replicate the second set of packets of the classified plurality of packets and sample the replicated second set of packets based on the sampling rate.

In some embodiments, the redundancy management logic is further configured to perform packet forwarding.

In some embodiments, to perform the packet forwarding, the redundancy management logic is further configured to receive a first set of processed packets from the first data plane and a second set of processed packets from the second data plane, discard the second set of processed packets, and forward the first set of processed packets to one or more corresponding destinations.

In some embodiments, to perform the packet forwarding, the redundancy management logic is further configured to transmit, to the second data plane, the second set of packets based on a failure in the first data plane, receive a set of processed packets from the second data plane, and forward the set of processed packets received from the second data plane to one or more corresponding destinations.

In some embodiments, a redundancy management logic is configured to classify a plurality of packets into at least a first category or a second category, transmit a first set of packets of the classified plurality of packets to the first data plane and the second data plane, sample a second set of packets of the classified plurality of packets based on a sampling rate, and transmit the second set of packets to the first data plane and the sampled second set of packets to the second data plane.

In some embodiments, the first data plane is an active data plane, and the second data plane is a standby data plane.

In some embodiments, the second data plane is configured to operate as the active data plane based on a failure of the first data plane, and wherein the redundancy management logic is further configured to transmit the second set of packets to the second data plane.

In some embodiments, a method includes classifying a plurality of packets into at least a first category or a second category, transmitting a first set of packets of the classified plurality of packets to a first data plane and a second data plane, sampling a second set of packets of the classified plurality of packets based on a sampling rate, and transmitting the second set of packets to the first data plane and the sampled second set of packets to the second data plane.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments that a networking logic may operate on a plurality of network devices in accordance with various embodiments of the disclosure;

FIG. 2 is a conceptual illustration of a network device implementing an optimized data plane redundancy management solution in accordance with various embodiments of the disclosure;

FIG. 3 is a conceptual illustration of a network device implementing an optimized data plane redundancy management solution in accordance with various embodiments of the disclosure;

FIG. 4 is a flowchart showing a process for optimized data plane redundancy management in a normal mode in accordance with various embodiments of the disclosure;

FIG. 5 is a flowchart showing a process for optimized data plane redundancy management in normal and failure management modes in accordance with various embodiments of the disclosure;

FIG. 6 is a flowchart showing a process for packet processing at a data plane in accordance with various embodiments of the disclosure; and

FIG. 7 is a conceptual block diagram for one or more devices capable of executing components and logic for implementing the functionality and embodiments in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that provide a data plane redundant configuration for a network device. In many embodiments, network devices may maintain an active data plane and a standby data plane. It should be appreciated that a data plane—also known as a forwarding plane or a forwarding engine—is an important component in many network devices, such as routers, switches, firewalls, or the like. Data planes may be responsible for processing and forwarding data packets between different network interfaces based on their destination addresses. Similarly, network devices, for example, routers, switches, etc., may also include a control plane responsible for making decisions regarding how data traffic should be handled. The control plane may be configured to handle various functionalities, including, but not limited to, routing and path selection, network addressing and address resolution, implementing Quality of Service (QOS) policies, network security, and device configuration.

In many embodiments, a standby data plane in a network device may be maintained in a hot standby state using a plurality of mechanisms. For example, sync messages from the active data plane to the standby data plane may be used to synchronize control plane state and configurations in the standby data plane. Similarly, to maintain the dynamic state, a linecard in the network device may replicate all incoming traffic from communication ports to both the active data plane and the standby data plane, and both the data planes forward the traffic. In additional embodiments, the linecard may be configured to drop traffic forwarded from the standby data plane in the transmit direction. In still additional embodiments, only one copy of the traffic is sent out from the network device. However, to achieve this functionality, the standby data plane may be required to handle all traffic coming into the network device, leading to increased power consumption, and necessitating more extensive cooling measures.

In additional embodiments, to maintain redundancy in the network, data plane redundant (DPR) systems may include a standby data plane kept ready or otherwise available in a hot standby state to take over the forwarding functions in case a failure is detected in the active data plane. For example, a linecard, serving as an interface between the chassis of the network device and external network connections, drops forwarded traffic from the standby data plane in the transmit direction if the active data plane does not fail. Thus, in many embodiments, only one copy of the traffic is sent out or otherwise communicated from the network device.

To ensure that the standby data plane is always ready to take over the functions of the active data plane, forwarding actions of the standby data plane maintain the states synchronized and enable the linecard to affect the failure handling quickly. When there is a failure in the active data plane, the only action required by the linecard is to start accepting traffic from the standby data plane, now serving as the new active data plane. This method, thus, requires the standby data plane to handle the entire incoming traffic into the network device along with the active data plane, which in turn leads to increased power consumption and necessitates more extensive cooling measures.

In many embodiments, the present disclosure provides an optimized data plane redundancy management with one or more intelligent linecards. A linecard, also known as a line module or an interface card, is a hardware component found in network devices, for example, routers, switches, access servers, or the like. Linecard may provide a network interface for connecting a network device to an external network. In an example scenario, the linecard of the present disclosure may be a part of a router. In another example, the linecard may be a part of a network monitoring device or a packet capturing solution used for network traffic monitoring.

In numerous embodiments, the linecard may receive a traffic stream. Instead of replicating all the traffic to the standby data plane, the linecard classifies a plurality of packets of the traffic into at least a first category or a second category. The plurality of packets can be classified into the first category, or the second category based on the determination of whether a packet of the plurality of packets comprises or is otherwise configured as a control packet or a data packet.

Examples of control packets may include, but are not limited to, Operations, Administration, and Maintenance (OAM) protocol packets. OAM packets are typically used for fault detection and isolation, performance monitoring of network connections and devices, remote diagnostics and troubleshooting of network devices, proactive monitoring of network devices, and other such functions. OAM packets may be used to maintain dynamic state in the standby data plane. Examples of OAM protocols may include, but are not limited to, Bidirectional Forwarding Detection (BFD protocol), Connectivity Fault Management protocol, or the like. BFD protocol may be used in computer networks to provide rapid detection of failures in the forwarding path between two network devices. Connectivity Fault Management protocol may be used in computer networks to monitor and diagnose connectivity issues within Ethernet networks.

In additional embodiments, the plurality of packets can be classified into the first category, or the second category based on, for example, an Internet Protocol (IP) precedence value, a differentiated services code point (DSCP) value, or a class of service (CoS) value associated with each packet. The IP precedence value is a 3-bit field within an IPV4 header and is used to prioritize packets based on their importance or class of service. IPv6 packets use Traffic Class field for packet prioritization. The Traffic Class field is 8 bits long and is used to indicate the class of the IPv6 packets. The first 6 bits of the Traffic Class field represent the Differentiated Services Code Point (DSCP) value, which is used to classify packets for prioritized delivery. In a similar manner, Dot1P bits, referred to as Priority Code Point (PCP) field in Ethernet networks, can also be used for packet classification and prioritization of Ethernet frames as they traverse network devices. In another example scenario, Multiprotocol Label Switching (MPLS) EXP (Experimental) bits, also known as EXP bits or EXP field, may be used for packet classification in MPLS networks. In more embodiments, the plurality of packets can be classified into the first category, or the second category based on Media Access Control (MAC) addresses associated with each packet. In an example scenario, network administrators can prioritize traffic for Layer 2 control packets that use specific destination MAC addresses as 01-80-C2-xx-xx-xx, for example, Link Aggregation Control Protocol (LACP) packets having destination MAC address as 01-80-C2-00-00-02.

In a non-limiting example, it is assumed that a first set of packets of the plurality of packets is classified into the first category and a remaining second set of packets of the plurality of packets is classified into the second category. In a variety of embodiments, the first category can be associated with a higher priority as compared to the second category. For example, the first category can be a high priority category and the second category can be a low priority category.

In additional embodiments, the linecard may transmit the first set of packets to a first data plane and a replicated version of the first set of packets (referred to as “replicated first set of packets”) to a second data plane. In various other embodiments, the linecard transmits a first set of packets of the classified plurality of packets to the first data plane and the second data plane. In a number of embodiments, the first data plane can be an active data plane and the second data plane can be a standby data plane. For example, the linecard may transmit control packets (e.g., OAM protocol packets, or the like) among the plurality of packets to the active data plane and replicated control packets to the standby data plane.

In further embodiments, the linecard may sample the second set of packets (e.g., data packets) based on a sampling rate. In still additional embodiments, the linecard may sample a second set of packets of the classified plurality of packets based on the sampling rate. The sampling rate for sampling of the second set of packets can be configured by the network administrator or can be configured based on one or more applications associated with the network device. Further, the sampling rate and sampling algorithm can be selected as per the requirement of the network device. In still more embodiments, the linecard may transmit the second set of packets to the first data plane (e.g., the active data plane) and the sampled second set of packets to the second data plane (e.g., the standby data plane). The sampled second set of packets enables the second data plane to learn information about the network such as updating MAC address tables, and other such information. In other words, instead of transmitting the entire replicated incoming traffic to the standby data plane, the linecard only transmits the replicated first set of packets and the sampled second set of packets to the standby data plane for processing.

In still further embodiments, when operating in normal mode, the linecard may accept all the forwarded traffic from the first data plane and discard the traffic forwarded by the second data plane. In still additional embodiments, when a failure is detected in the first data plane, instead of transmitting the sampled set of packets to the second data plane, the linecard may start transmitting the second set of packets to the second data plane (now serving as the new active data plane). The linecard may further start to accept all the forwarded traffic from the second data plane, thus restoring the traffic without much disruption.

Advantageously, the device of the present disclosure may provide a considerable reduction of traffic load on the standby data plane while maintaining all the key functions. Thus, there is lower power utilization and thereby reduced cooling requirements. This contributes to greener, more power efficient, and sustainable networks.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

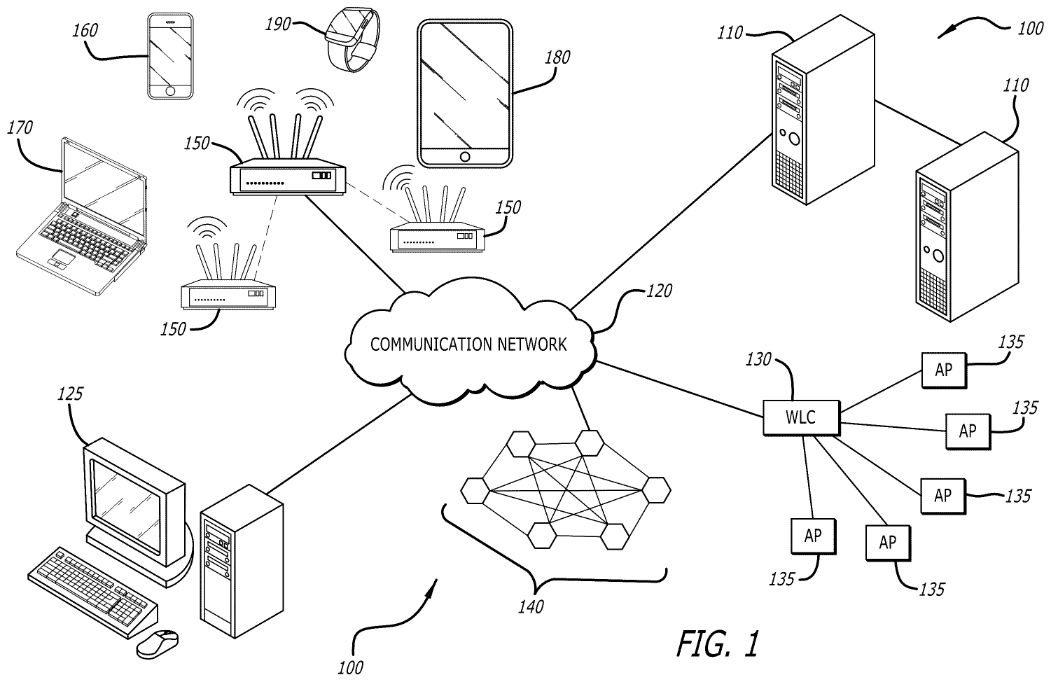

Referring to FIG. 1, a conceptual network diagram 100 of various environments that a networking logic may operate on a plurality of network devices in accordance with various embodiments of the disclosure is shown. Those skilled in the art will recognize that the networking logic can include various hardware and/or software deployments and can be configured in a variety of ways. In many embodiments, the networking logic can be configured as a standalone device, exist as a logic in another network device, be distributed among various network devices operating in tandem, or remotely operated as part of a cloud-based network management tool. In further embodiments, one or more servers 110 can be configured with the networking logic or can otherwise operate as the networking logic. In many embodiments, the networking logic may operate on one or more servers 110 connected to a communication network 120 (shown as the “Internet”). The communication network 120 can include wired networks or wireless networks. The networking logic can be provided as a cloud-based service that can service remote networks, such as, but not limited to a deployed network 140.

However, in additional embodiments, the networking logic may be operated as a distributed logic across multiple network devices. In the embodiment depicted in FIG. 1, a plurality of network access points (APs) 150 can operate as the networking logic in a distributed manner or may have one specific device operate as the networking logic for all of the neighboring or sibling APs 150. The APs 150 may facilitate Wi-Fi connections for various electronic devices, such as but not limited to, mobile computing devices including laptop computers 170, cellular phones 160, portable tablet computers 180 and wearable computing devices 190.

In further embodiments, the networking logic may be integrated within another network device. In the embodiment depicted in FIG. 1, a wireless LAN controller (WLC) 130 may have an integrated networking logic that the WLC 130 can use to monitor or control power consumption of the APs 135 that the WLC 130 is connected to, either wired or wirelessly. In still more embodiments, a personal computer 125 may be utilized to access and/or manage various aspects of the networking logic, either remotely or within the network itself. In the embodiment depicted in FIG. 1, the personal computer 125 communicates over the communication network 120 and can access the networking logic of the servers 110, or the network APs 150, or the WLC 130.

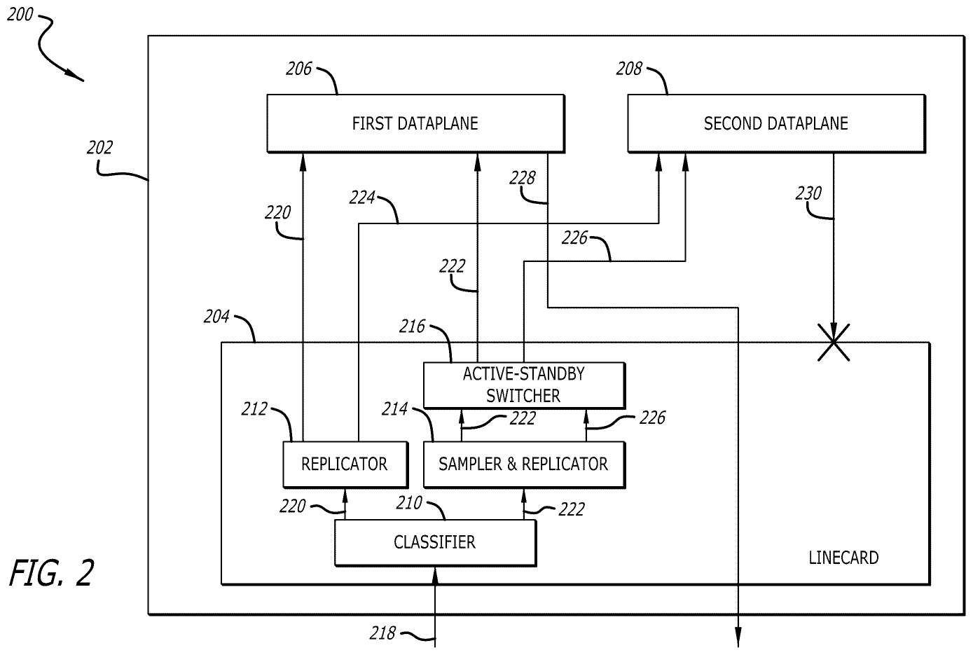

Although a specific embodiment for various environments that the networking logic may operate on a plurality of network devices suitable for carrying out the various steps, processes, methods, and operations described herein is discussed with respect to FIG. 1, any of a variety of systems and/or processes may be utilized in accordance with embodiments of the disclosure. In many non-limiting examples, the networking logic may be provided as a device or software separate from the WLC 130 or the networking logic may be integrated into the WLC 130. The elements depicted in FIG. 1 may also be interchangeable with other elements of FIGS. 2-10 and as required to realize a particularly desired embodiment.

Referring to FIG. 2, a conceptual illustration 200 of a network device 202 implementing an optimized data plane redundancy management solution in accordance with various embodiments of the disclosure is shown. The embodiments depicted in the conceptual illustration 200 may show a scenario where the network device 202 is operating in a normal mode (e.g., no data plane failure management mode) in which a linecard accepts network traffic forwarded from an active data plane while rejecting network traffic forwarded by a standby data plane. In many embodiments, the network traffic may refer to a plurality of packets 218 that are received by the network device 202 from another network device. Examples of the network device 202 may include, but are not limited to, a router, a switch, an access point, or the like.

In a number of embodiments, the network device 202 may include a linecard 204 that serves as an interface for the network device 202. The linecard 204 may provide physical connectivity to the network device 202, in the form of one or more ports or interfaces, to interface with various network media types, for example, Ethernet, Fast Ethernet, Gigabit Ethernet, fiber-optic, serial connections, or the like. In a variety of embodiments, the network device 202 may include a first data plane 206 and a second data plane 208 that are communicatively coupled to the linecard 204. In an example scenario, the first data plane 206 may serve as an active data plane, while the second data plane 208 may serve as a standby data plane.

In some embodiments, the linecard 204 may include a classifier 210 configured to classify the received plurality of packets 218 into a first category and a second category. The first category may be associated with a higher priority than the second category. Further, the first category may be associated with those packets (e.g., control packets) that are essential to maintain dynamic states within a data plane, for example, packets carrying information such as Operations, Administration, and Maintenance (OAM) protocol information, forwarding information (e.g., Media Access Control (MAC) address tables, Address Resolution Protocol (ARP) tables, routing tables, or the like), routing adjacencies, and similar information necessary to maintain dynamic states in a data plane (e.g., the first data plane 206 and the second data plane 208). OAM packets are typically used for fault detection and isolation, performance monitoring of network connections and devices, remote diagnostics and troubleshooting of network devices, proactive monitoring of network devices, and other such functions. Examples of OAM protocols may include, but are not limited to, Bidirectional Forwarding Detection (BFD protocol), Connectivity Fault Management protocol, or the like. Likewise, the second category may be associated with those packets (e.g., data packets) that carry data traffic (e.g., data payloads). For example, data traffic may include Internet browsing data packets, email messages, audio/video streaming packets, file transfer packets, cloud services, and other similar data packets.

In numerous embodiments, the classifier 210 may classify the received plurality of packets 218 based on an Internet Protocol (IP) precedence value, a differentiated services code point (DSCP) value, or a class of service (CoS) value associated with each packet. The IP precedence value is a 3-bit field within an IPV4 header and is used to prioritize packets based on their importance or class of service. IPv6 packets use Traffic Class field for packet prioritization. The Traffic Class field is 8 bits long and is used to indicate the class of the IPV6 packets. The first 6 bits of the Traffic Class field represent the Differentiated Services Code Point (DSCP) value, which is used to classify packets for prioritized delivery. In another example scenario, Multiprotocol Label Switching (MPLS) EXP (Experimental) bits, also known as EXP bits or EXP field, may be used for packet classification in MPLS networks. In more embodiments, the plurality of packets can be classified into the first category or the second category based on Media Access Control (MAC) addresses associated with each packet. In an example scenario, the DSCP value for a packet carrying high-priority traffic is Expedited Forwarding (EF) class. The EF class is commonly used for real-time and latency-sensitive applications such as voice calls, video conferencing, or the like. The DSCP value for EF class is typically 101110 in binary notation or 46 in decimal notation.

In a non-limiting example, it is assumed that a first set of packets 220 among the plurality of packets 218 is classified into the first category and a remaining second set of packets 222 among the plurality of packets 218 is classified into the second category. The first set of packets 220 may include control packets and the second set of packets 222 may include data packets. In more embodiments, the linecard 204 may further include a replicator 212 communicatively coupled to the classifier 210. The replicator 212 may be configured to receive the first set of packets 220 from the classifier 210. The replicator 212 may replicate the first set of packets 220 to generate a replicated first set of packets 224. In an example scenario, the replicator 212 may duplicate or mirror the first set of packets 220 stored in a temporary buffer. Such copying process can be executed using specialized hardware circuits configured for high-speed packet processing. For example, the replicator 212 may use a Serializer/Deserializer (SerDes) multiplexer, network taps, port mirroring/spanning techniques, or the like to replicate the first set of packets 220 (e.g., a traffic stream categorized into the first category). In additional embodiments, the replicator 212 may transmit the first set of packets 220 and the replicated first set of packets 224 to the first data plane 206 and the second data plane 208, respectively. Thus, both the first data plane 206 and the second data plane 208 receive all those packets that are classified into the first category.

In further embodiments, the linecard 204 may include a sampler & replicator 214 communicatively coupled to the classifier 210. The sampler & replicator 214 may be configured to receive the second set of packets 222 from the classifier 210. The sampler & replicator 214 may replicate the second set of packets 222 and may sample the replicated second set of packets at a sampling rate to obtain a sampled second set of packets 226. The sampler & replicator 214 may use a SerDes multiplexer, network taps, port mirroring/spanning techniques, or the like to replicate the second set of packets 222 (e.g., a traffic stream categorized into the second category). The sampler & replicator 214 may further use one or more sampling techniques, for example, but not limited to, random sampling, uniform sampling, systematic sampling, adaptive sampling, etc. to obtain the sampled second set of packets 226 from the replicated second set of packets.

In still more embodiments, the sampler & replicator 214 may transmit the second set of packets 222 and the sampled second set of packets 226 to a switching element (e.g., an active-standby switcher 216) in the linecard 204. The active-standby switcher 216 may be configured to operate in one of the normal mode or the failure management mode. For example, the active-standby switcher 216 may operate in the normal mode when both the first data plane 206 and the second data plane 208 are operating normally, e.g., without any failure. The active-standby switcher 216 may operate in the failure management mode when a failure is detected in the first data plane 206. The embodiments depicted in the conceptual illustration 200 may show a scenario where the active-standby switcher 216 is operating in the normal mode.

In still further embodiments, in the normal mode, the active-standby switcher 216 may transmit the second set of packets 222 to the first data plane 206 and the sampled second set of packets 226 to the second data plane 208. In other words, instead of transmitting all the second set of packets 222 to both the first data plane 206 and the second data plane 208, the second set of packets 222 is only transmitted to the first data plane 206 and only the sampled second set of packets 226 is transmitted to the second data plane 208. Thus, reducing processing burden on the second data plane 208 serving as the standby data plane during normal mode of operation.

In still yet more embodiments, the first data plane 206 and the second data plane 208 may perform various processing operations on packets received from the linecard 204. In other words, the first data plane 206 may perform various processing operations on the first set of packets 220 and the second set of packets 222 to obtain a first set of processed packets 228. Similarly, the second data plane 208 may perform various processing operations on the replicated first set of packets 224 and the sampled second set of packets 226 to obtain a second set of processed packets 230. For example, a data plane may perform packet parsing function to extract information such as source and destination addresses, protocol type, Virtual Local Area Network (VLAN) tags, or the like from a packet. Data plane may also make forwarding decisions based on the information extracted from packet headers to determine appropriate outbound interface or next-hop device for each packet. The forwarding decisions may be based on routing tables, forwarding tables, access control lists (ACLs), or any other such forwarding information maintained by the data planes.

In still additional embodiments, the first data plane 206 may forward the first set of processed packets 228 to the linecard 204. Similarly, the second data plane 208 may also forward the second set of processed packets 230 to the linecard 204. In additional embodiments, the linecard 204 may forward the first set of processed packets 228, received from the first data plane 206, to one or more corresponding destinations. In certain embodiments, the linecard 204 may discard the second set of processed packets 230, received from the second data plane 208. For example, when there is no fault detected in the first data plane 206 (e.g., active data plane), the linecard 204 only accepts processed packets received from the first data plane 206 and rejects processed packets received from the second data plane 208, in order to avoid duplicate copies of traffic packets be sent out from the network device 202.

Although a specific embodiment of a network device implementing an optimized data plane redundancy management solution suitable for carrying out the various steps, processes, methods, and operations described herein is discussed with respect to FIG. 2, any of a variety of systems and/or processes may be utilized in accordance with embodiments of the disclosure. For example, in yet more embodiments, the classifier 210 can classify the plurality of packets 218 based on type of applications associated with the plurality of packets 218, for example, a packet associated with an application requiring real-time traffic data may be categorized as high-priority packet and may be classified into the first category. In an example scenario, Voice over IP (VOIP) applications such as voice and video calls, online gaming, live video streaming services, or the like may rely on real-time transmission of packets and any delay or jitter in delivering these packets can result in poor Quality-of-Service (QOS). The elements depicted in FIG. 2 may also be interchangeable with other elements of FIGS. 1 and 3-5 as required to realize a particularly desired embodiment.

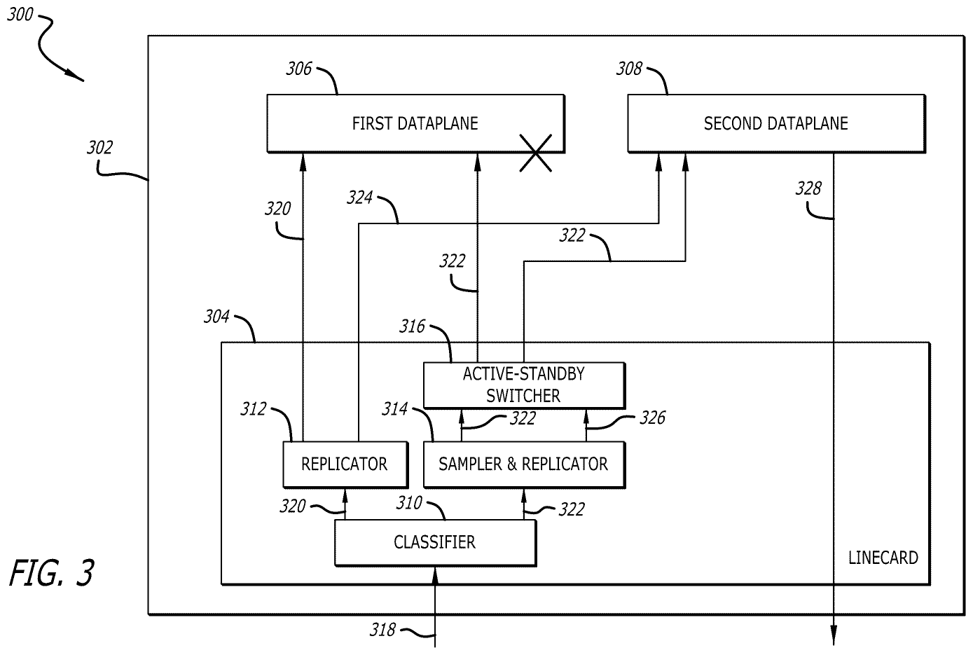

Referring to FIG. 3, a conceptual illustration 300 of a network device 302 implementing an optimized data plane redundancy management solution in accordance with various embodiments of the disclosure is shown. The embodiments depicted in the conceptual illustration 300 may show a scenario where the network device 302 is operating in a failure management mode in which a linecard accepts network traffic forwarded from a standby data plane due to a failure detected in an active data plane. Examples of the network device 302 may include, but are not limited to, a router, a switch, an access point, or the like.

In a number of embodiments, the network device 302 may include a linecard 304 that serves as an interface for the network device 302. The linecard 304 may provide physical connectivity to the network device 302, in the form of one or more ports or interfaces, to interface with various network media types, for example, Ethernet, Fast Ethernet, Gigabit Ethernet, fiber-optic, serial connections, or the like. In a variety of embodiments, the network device 302 may include a first data plane 306 and a second data plane 308 that are communicatively coupled to the linecard 304. In an example scenario, the first data plane 306 may serve as an active data plane, while the second data plane 308 may serve as a standby data plane.

In many embodiments, the network device 302 may receive network traffic including a plurality of packets 318 that are received from another network device. In some embodiments, the linecard 304 may include a classifier 310 configured to classify the plurality of packets 318 into a first category and a second category. The first category may be associated with a higher priority than the second category. Further, the first category may be associated with those packets (e.g., control packets) that are essential to maintain dynamic states within a data plane, for example, packets carrying information such as OAM information, forwarding information (e.g., MAC address tables, ARP tables, routing tables, or the like), routing adjacencies, and similar information necessary to maintain dynamic states in a data plane (e.g., the first data plane 306 and the second data plane 308). Likewise, the second category may be associated with those packets (e.g., data packets) that carry data traffic (e.g., data payloads). For example, data traffic may include Internet browsing data packets, email messages, audio/video streaming packets, file transfer packets, cloud services, and other similar non time-sensitive data.

In numerous embodiments, the classifier 310 may classify the received plurality of packets 318 into the first category or the second category based on an Internet Protocol (IP) precedence value, a differentiated services code point (DSCP) value, or a class of service (CoS) value associated with each packet. The IP precedence value is a 3-bit field within an IPv4 header and is used to prioritize packets based on their importance or class of service. IPv6 packets use Traffic Class field for packet prioritization. The Traffic Class field is 8 bits long and is used to indicate the class of the IPV6 packets. The first 6 bits of the Traffic Class field represent the Differentiated Services Code Point (DSCP) value, which is used to classify packets for prioritized delivery.

In a non-limiting example, it is assumed that a first set of packets 320 among the plurality of packets 318 is classified into the first category and a remaining second set of packets 322 among the plurality of packets 318 is classified into the second category. The first set of packets 320 may include control packets and the second set of packets 322 may include data packets. In more embodiments, the linecard 304 may further include a replicator 312 communicatively coupled to the classifier 310. The replicator 312 may be configured to receive the first set of packets 320 from the classifier 310. The replicator 312 may replicate the first set of packets 320 to generate a replicated first set of packets 324.

In an example scenario, the replicator 312 may duplicate or mirror the first set of packets 320 stored in a temporary buffer. Such copying process can be executed using specialized hardware circuits configured for high-speed packet processing. For example, the replicator 312 may use a SerDes multiplexer, network taps, port mirroring/spanning techniques, or the like to replicate the first set of packets 320 (e.g., a traffic stream categorized into the first category). In additional embodiments, the replicator 312 may transmit the first set of packets 320 and the replicated first set of packets 324 to the first data plane 306 and the second data plane 308, respectively. Thus, both the first data plane 306 and the second data plane 308 receive all those packets that are classified into the first category.

In further embodiments, the linecard 304 may include a sampler & replicator 314 communicatively coupled to the classifier 310. The sampler & replicator 314 may be configured to receive the second set of packets 322 from the classifier 310. The sampler & replicator 314 may replicate the second set of packets 322 and may sample the replicated second set of packets at a sampling rate to obtain a sampled second set of packets 326. The sampler & replicator 314 may use a SerDes multiplexer, network taps, port mirroring/spanning techniques, or the like to replicate the second set of packets 322 (e.g., a traffic stream categorized into the second category). The sampler & replicator 314 may further use one or more sampling techniques, for example, but not limited to, random sampling, uniform sampling, systematic sampling, adaptive sampling, etc. to obtain the sampled second set of packets 326 from the replicated second set of packets.

In still more embodiments, the sampler & replicator 314 may transmit the second set of packets 322 and a sampled second set of packets 326 to a switching element (e.g., active-standby switcher 316). The active-standby switcher 316 may be configured to operate in one of the normal mode or the failure management mode. For example, the active-standby switcher 316 may operate in the normal mode when both the first data plane 306 and the second data plane 308 are operating normally, e.g., without any failure. In the normal mode, the active-standby switcher 316 may transmit the second set of packets 322 to the first data plane 306 and the sampled second set of packets 326 to the second data plane 308.

However, when a failure is detected in the first data plane 306, the active-standby switcher 316 may start operating in the failure management mode. The embodiments depicted in the conceptual illustration 300 may show a scenario where the active-standby switcher 316 is operating in the failure management mode. In certain embodiments, the linecard 304 may receive information regarding the failure of the first data plane 306 from a control plane of the network device 302. In numerous embodiments, the network device 302 may include a fault detection and management subsystem to detect and handle the failures or faults in components of the network device 302. In such embodiments, the linecard 304 may receive information regarding the failure of the first data plane 306 from the fault detection and management subsystem of the network device 302.

In the event of detection of a failure of the first data plane 306, the active-standby switcher 316 may perform a switchover function and start operating in the failure management mode. In the failure management mode, the active-standby switcher 316, instead of transmitting the sampled second set of packets 326 to the second data plane 308, may transmit the second set of packets 322 (e.g., packets classified in the second category) to the second data plane 308 and the sampled second set of packets 326 to the first data plane 306. As a result, the operations that were performed by the first data plane 306 can now be performed by the second data plane 308 without any service disruption.

In still yet more embodiments, the first data plane 306 may be unable to perform one or more processing functions due to failure. The second data plane 308 may perform various processing operations on packets received from the linecard 304. In other words, the second data plane 308 may perform various processing operations on the replicated first set of packets 324 and the second set of packets 322 to obtain a set of processed packets 328. For example, a data plane may perform packet parsing function to extract information such as source and destination addresses, protocol type, VLAN tags, or the like from a packet. Data plane may also make forwarding decisions based on the information extracted from packet headers to determine the appropriate outbound interface or next-hop device for each packet. The forwarding decisions may be based on routing tables, forwarding tables, access control lists (ACLs), or any other such forwarding information maintained by the data planes.

In yet more embodiments, the second data plane 308 may forward the set of processed packets 328 to the linecard 304. The set of processed packets 328 can include processed packets of the replicated first set of packets 324 and the second set of packets 322. In many further embodiments, the linecard 304 may forward the set of processed packets 328 to one or more corresponding destinations.

Although a specific embodiment of a network device implementing an optimized data plane redundancy management solution suitable for carrying out the various steps, processes, methods, and operations described herein is discussed with respect to FIG. 3, any of a variety of systems and/or processes may be utilized in accordance with embodiments of the disclosure. For example, in many additional embodiments, the active-standby switcher 316 may be a part of the sampler & replicator 314. The sampler & replicator 314 may thus be capable of taking the decision to switchover from an active data plane to a standby data plane based on a failure of the active data plane. The elements depicted in FIG. 3 may also be interchangeable with other elements of FIGS. 1-2 and 4-7 as required to realize a particularly desired embodiment.

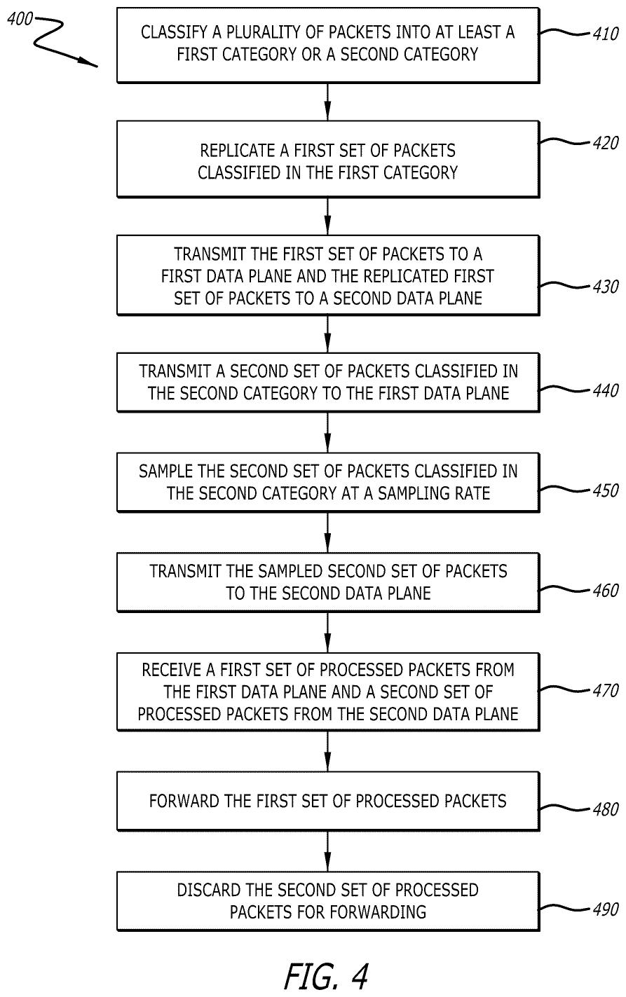

Referring to FIG. 4, a flowchart showing a process 400 for optimized data plane redundancy management in a normal mode in accordance with various embodiments of the disclosure is shown. In many embodiments, the process 400 may classify a plurality of packets into at least a first category or a second category (block 410). The classification of a packet into the first category or the second category may be based on the determination of whether the packet is a control packet or a data packet. For example, if the packet is a control packet, the packet may be classified into the first category or if the packet is a data packet, the packet may be classified into the second category. For example, the packet may be classified into the first category based on an IP precedence value, DSCP value, a CoS value associated with the packet, or the like. The packet may also be classified into the first category based on a Media Access Control (MAC) address associated with the packet, or the packet being an OAM packet. In a variety of embodiments, a first set of packets of the plurality of packets may be classified into the first category. Similarly, a second set of packets of the plurality of packets may be classified into the second category. In a number of embodiments, the plurality of packets may be classified by a linecard of a network device (e.g., a router, a switch, or the like).

In some embodiments, the process 400 may replicate the first set of packets classified in the first category (block 420). In more embodiments, the process 400 may employ a low-level device (such as a SerDes multiplexer) to replicate the first set of packets. Replicating the first set of packets classified in the first category ensures redundancy and high availability in the network.

In additional embodiments, the process 400 may transmit the first set of packets to a first data plane and the replicated first set of packets to a second data plane (block 430). In further embodiments, the first data plane may be an active data plane of the network device and the second data plane may be a standby data plane of the network device. The active data plane may enable efficient handling of packets and ensuring that packets are correctly routed to their intended destinations. The standby data plane may use the replicated first set of packets to gather information about the network and maintain dynamic OAM states of the network. By transmitting duplicate copies of the first set of packets to the standby data plane, network administrators can ensure that critical data (e.g., dynamic OAM states) is not lost in the event of a failure or outage of the active data plane.

In further embodiments, the process 400 may transmit a second set of packets classified in the second category to the first data plane (block 440). In still more embodiments, the second set of packets may include data packets related to user data payload. User data payload may refer to actual data portion of a network packet that carries the information intended for transmission between network devices. For example, in an Internet Protocol (IP) packet, the user data payload can include various user-generated content, such as files, email messages, web page content or the like.

In still further embodiments, the process 400 may sample the second set of packets classified in the second category at a sampling rate (block 450). In still additional embodiments, the sampling rate for sampling the second set of packets can be configured based on specific requirements. In an example scenario, the sampling of traffic packets at a user-defined rate may include capturing a subset of traffic packets at regular or random intervals, according to a specified sampling rate or frequency, such as a fixed number of packets sampled per second. The subset of traffic packets thus captured provides insights into network behavior or enables synchronization of network devices for ensuring redundancy.

In still additional embodiments, the process 400 may transmit the sampled second set of packets to the second data plane (block 460). In additional embodiments, the sampled second set of packets are transmitted to the standby data plane. The sampled second set of packets may provide a small sample of data traffic to the standby data plane. In certain embodiments, the sampled second set of packets may be used by the standby data plane to learn information such as MAC addresses of devices present in the network, network topology, etc.

In certain embodiments, the process 400 may receive a first set of processed packets from the first data plane and a second set of processed packets from the second data plane (block 470). In yet more embodiments, the linecard may receive the first set of processed packets from the first data plane (e.g., the active data plane) and the second set of processed packets from the second data plane (e.g., the standby data plane). In still yet more embodiments, the first data plane and the second data plane may perform various processing operations on packets from the linecard. For example, a data plane can perform packet parsing function on received packets to extract information such as source and destination addresses, protocol type, VLAN tags, or the like. Data plane may also make forwarding decisions based on the information extracted from packet headers to determine appropriate outbound interface or next-hop device for each of the packets. The forwarding decisions may be based on routing tables, forwarding tables, ACLs, or any other such forwarding information maintained by the data planes.

In many further embodiments, the process 400 may forward the first set of processed packets (block 480). In many additional embodiments, the process 400 may receive the first set of processed packets from the first data plane. For example, the linecard may receive the first set of processed packets from the active data plane and forward the first set of processed packets to corresponding one or more destinations.

In still yet further embodiments, the process 400 may discard the second set of processed packets for forwarding (block 490). In still yet additional embodiments, the linecard may discard the second set of processed packets forwarded by the second data plane. For example, the linecard may discard the processed packets received from the standby data plane to avoid having duplicate copies of packets sent out from the network device.

Although a specific embodiment for data plane operation in normal mode suitable for carrying out the various steps, processes, methods, and operations described herein is discussed with respect to FIG. 4, any of a variety of systems and/or processes may be utilized in accordance with embodiments of the disclosure. For example, in several embodiments, the first data plane and the second data plane may process received packets to implement security policies, perform packet filtering, encryption/decryption of the packets, and protect the network from unauthorized access or malicious traffic. In an example scenario, the first data plane, when operating in normal mode, may discard certain packets based on the determination that the packets violate security policies or fail security checks, such as packets containing malicious payloads, unauthorized access attempts, or the like. The elements depicted in FIG. 4 may also be interchangeable with other elements of FIGS. 1-3 and 5-7 as required to realize a particularly desired embodiment.

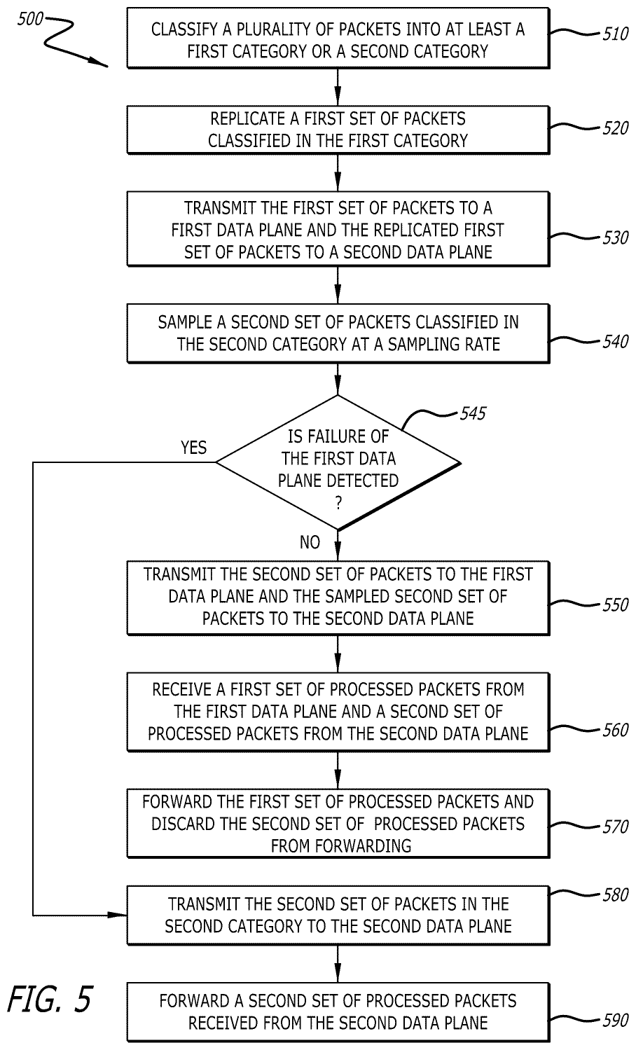

Referring to FIG. 5, a flowchart showing a process 500 for optimized data plane redundancy management in normal and failure management modes in accordance with various embodiments of the disclosure is shown. In many embodiments, the process 500 may classify a plurality of packets into at least a first category or a second category (block 510). The classification of a packet into the first category or the second category may be based on a determination of whether the packets is a control packet or a data packet. In a variety of embodiments, a first set of packets of the plurality of packets may be classified into the first category. The first set of packets may refer to packets having higher priority, for example, OAM packets, routing protocol packets, real-time traffic packets, or the like. Similarly, a second set of packets of the plurality of packets may be classified into the second category. The second set of packets may refer to packets having low priority, for example, packets carrying user data payload such as email messages, internet browsing, or the like. In a number of embodiments, the plurality of packets may be classified by a linecard of a network device (e.g., a router, a switch, or the like).

In some embodiments, the process 500 may replicate the first set of packets classified in the first category (block 520). In more embodiments, the process 500 may employ a low-level device (such as a SerDes multiplexer) to replicate the first set of packets. Replicating the first set of packets classified in the first category may ensure redundancy and high availability in the network.

In further embodiments, the process 500 may transmit the first set of packets to a first data plane and the replicated first set of packets to a second data plane (block 530). In still more embodiments, the first data plane may be an active data plane and the second data plane may be a standby data plane of the network device. The active data plane may enable efficient handling of packets and ensure that packets are correctly routed to their intended destinations. The standby data plane may use the replicated first set of packets to gather information about the network and maintain dynamic state of OAM protocols in the standby data plane.

In still further embodiments, the process 500 may sample the second set of packets, classified in the second category, at a sampling rate (block 540). In still additional embodiments, the sampling rate for sampling the second set of packets can be configured based on specific requirements. In an example scenario, the sampling of traffic packets at a user-defined rate may include capturing a subset of traffic packets at regular or random intervals, according to a specified sampling rate or frequency. The subset of traffic packets thus captured provides insights into network behavior or enables synchronization of network devices for ensuring redundancy.

In additional embodiments, the process 500 may detect if there is a failure of the first data plane (block 545). In certain embodiments, a linecard may receive an indication regarding the failure of the first data plane. For example, the linecard can receive the indication regarding the failure of the first data plane acting as the active data plane. The network device can also employ a heartbeat mechanism to periodically send heartbeat messages between different components of the network device. If the active data plane fails to respond to the heartbeat message within a specified time frame, it indicates a failure of the active data plane. In still yet more embodiments, the communication channel between the control plane and the active data plane may be monitored to detect if the active data plane has stopped responding, indicating failure of the active data plane. When no failure in the first data plane is detected, in many further embodiments, the process 500 may transmit the second set of packets to the first data plane and the sampled second set of packets to the second data plane (block 550). In many additional embodiments, the linecard may transmit the second set of packets to the active data plane and the sampled second set of packets to the standby data plane.

In still yet additional embodiments, the process 500 may receive a first set of processed packets from the first data plane and a second set of processed packets from the second data plane (block 560). The linecard may receive the first set of processed packets that includes the processed first set of packets and the processed second set of packets from the active data plane. The linecard may receive the second set of processed packets that includes the processed first set of packets and the processed sampled set of packets from the standby data plane.

In several more embodiments, the process 500 may forward the first set of processed packets and discard the second set of processed packets (block 570). The linecard may forward the first set of processed packets based on the information provided by the active data plane regarding appropriate outbound interfaces or next-hop devices for each packet. The linecard may discard the second set of processed packets to avoid having duplicate packet copies sent out from the network device.

However, in case a failure is detected in the first data plane, in numerous embodiments, the process 500 may transmit the second set of packets in the second category to the second data plane (block 580) and the sampled second set of packets to the first data plane. In an example scenario, the detection of failure in the first data plane indicates a failure of the active data plane. In order to efficiently and quickly handle the failover situation, the linecard can transmit the second set of packets classified in the second category to the second data plane acting as the standby data plane, instead of transmitting the sampled second set of packets to the second data plane. In various embodiments, the second data plane takes over the functionality of the first data plane and acts as a new active data plane configured to process the first set of packets and the second set of packets.

In numerous additional embodiments, the process 500 may forward a second set of processed packets received from the second data plane (block 590). In further additional embodiments, in case of the failure of the first data plane (old active data plane), the linecard starts accepting the second set of processed packets received from the standby data plane, now referred to as the new active data plane. In a variety of embodiments, the linecard may forward the second set of processed packets received from the second data plane (the new active data plane) based on the forwarding decisions provided by the second data plane.

Although a specific embodiment for optimized data plane redundancy management in normal and failure management modes suitable for carrying out the various steps, processes, methods, and operations described herein is discussed with respect to FIG. 5, any of a variety of systems and/or processes may be utilized in accordance with embodiments of the disclosure. For example, in numerous embodiments, the linecard may employ a switching element that facilitates the switchover from the first data plane to the second data plane based on the determination of the failure of the first data plane. The elements depicted in FIG. 5 may also be interchangeable with other elements of FIGS. 1-4 and 6-7 as required to realize a particularly desired embodiment.

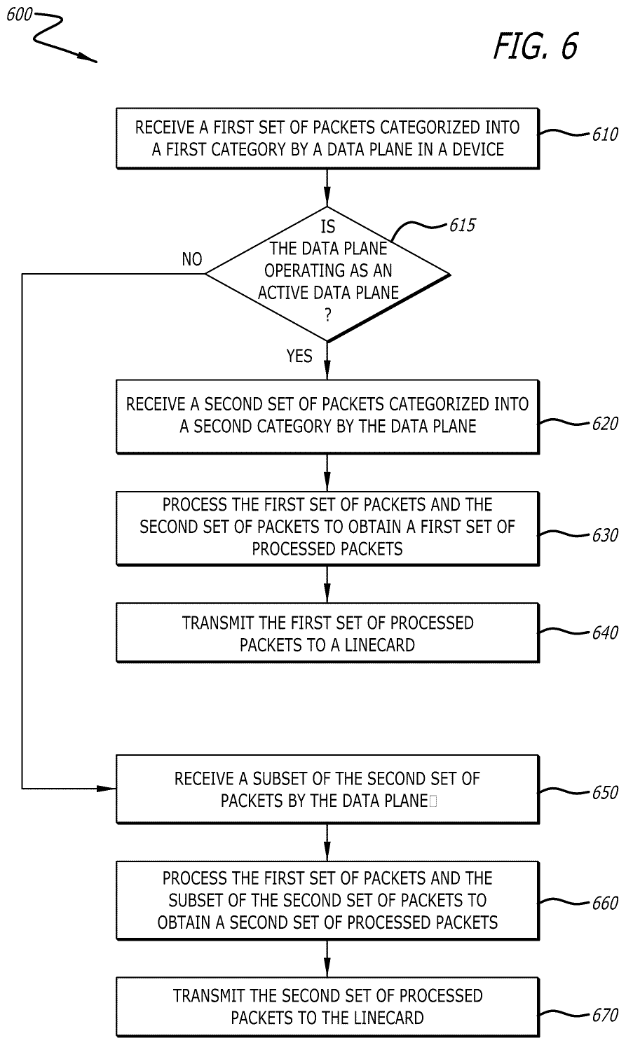

Referring to FIG. 6, a flowchart showing a process 600 for packet processing at a data plane in accordance with various embodiments of the disclosure is shown is shown. In many embodiments, the process 600 may receive a first set of packets categorized (or classified) into a first category by a data plane of a device (block 610). In a variety of embodiments, a data plane present in a network device may receive the first set of packets classified into the first category from a linecard. In a number of embodiments, the network device may be a router, a switch, a firewall, or the like including one or more data planes. The one or more data planes may function to process packets and forward the packets from ingress ports to egress ports based on the forwarding or routing decisions made by the network device. The functions may involve examination of packet headers to identify source and destination addresses, applying forwarding rules to the packets, and determining the next-hop destination for each packet.

In additional embodiments, the first set of packets may be categorized into the first category based on the determination whether the first set of packets are control packets, Operations, Administration, and Maintenance (OAM) protocol packets, Connectivity Fault Management (CFM) protocol packets, or the like. In more of the embodiments, the first set of packets categorized into the first category may refer to high priority network traffic. For instance, the first set of packets may be categorized into the first category based on an IP precedence value, a DSCP value, or a CoS value associated with each of the first set of packets.

In more of the embodiments, the process 600 may determine whether the data plane is operating as an active data plane (block 615). The active data plane may refer to the data plane that is fully operational and capable of processing and forwarding network traffic. For example, the active data plane is capable of forwarding packets based on the routing or switching table of the network device.

When the data plane is operating as the active data plane, in additional embodiments, the process 600 may receive a second set of packets categorized into a second category (e.g., by the data plane) (block 620). In further embodiments, the data plane may receive the second set of packets from a linecard. In still more embodiments, the second set of packets categorized into the second category may refer to data packets related to user data payload or low priority traffic. Low priority traffic may refer to non-time-sensitive or less critical data such as background traffic packets (software updates, large file downloads, or the like), web browsing, email traffic packets, and other similar non-critical service data packets.

In still further embodiments, the process 600 may process the first set of packets and the second set of packets to obtain a first set of processed packets (block 630). The data plane, in still additional embodiments, may process the received first set of packets categorized as high priority packets and the received second set of packets categorized as low priority packets. The data plane may obtain the first set of processed packets by parsing the first set of packets and the second set of packets for forwarding information, modifying packet headers, performing encryption or decryption, and other packet manipulation tasks. For example, in network scenarios using Network Address Translation (NAT), the data plane may modify packet headers to translate IP addresses and port numbers between public and private address realms. In another example scenario, in situations where the packets may need to be fragmented due to size limitations or Maximum Transmission Unit (MTU) constraints, the data plane may modify the packet headers to indicate the fragmentation process and reassemble fragmented packets at destination.

In many embodiments, the process 600 may transmit the first set of processed packets to a linecard (block 640). In certain embodiments, the data plane operating as the active data plane may transmit the first set of processed packets to the linecard. The linecard may forward the first set of processed packets to one or more corresponding destinations.

When the data plane is not operating as the active data plane, in yet more embodiments, the process 600 may receive a subset of the second set of packets by the data plane (block 650). In still yet more embodiments, the subset of second set of packets may be generated by sampling a replicated version of the second set of packets at a sampling rate. The sampling rate may be specified as a fixed number of packets sampled in a specified time interval or as a percentage of total network traffic. In many further embodiments, the subset of second set of packets may be transmitted to a standby data plane used for achieving data plane redundancy in the network.

In many additional embodiments, the process 600 may process the first set of packets and the subset of the second set of packets to obtain a second set of processed packets (block 660). In still yet further embodiments, the standby data plane may receive the first set of packets and the subset (e.g., sampled set) of the second set of packets from the linecard. The first set of packets may refer to the control packets, the OAM packets, other high priority packets, or the like. The first set of packets received by the standby data plane may be used to maintain the dynamic state information, network topology information, etc. in sync with those in the active data plane to ensure quick switchover to the standby data plane in case of a failure of the active data plane.

In still yet additional embodiments, the process 600 may transmit the second set of processed packets to the linecard (block 670). The second set of processed packets may be transmitted by the standby data plane to the linecard. In several embodiments, the linecard may discard the second set of processed packets transmitted by the standby data plane based on the determination that the active data plane is operating in a normal mode. The standby data plane transmits the second set of processed packets to the linecard to synchronize the states and to enable the linecards to affect the failure handling quickly.

Although a specific embodiment for packet processing at a data plane suitable for carrying out the various steps, processes, methods, and operations described herein is discussed with respect to FIG. 6, any of a variety of systems and/or processes may be utilized in accordance with embodiments of the disclosure. For example, in several more embodiments, the network device may include a plurality of standby data planes to provide greater resiliency in the network. In an example scenario, if a failure is detected in the active data plane, an active-standby switcher component present in the linecard of the network device may determine which standby data plane among the plurality of the standby data planes may be used for redundancy management. The elements depicted in FIG. 6 may also be interchangeable with other elements of FIGS. 1-5 and 7 as required to realize a particularly desired embodiment.

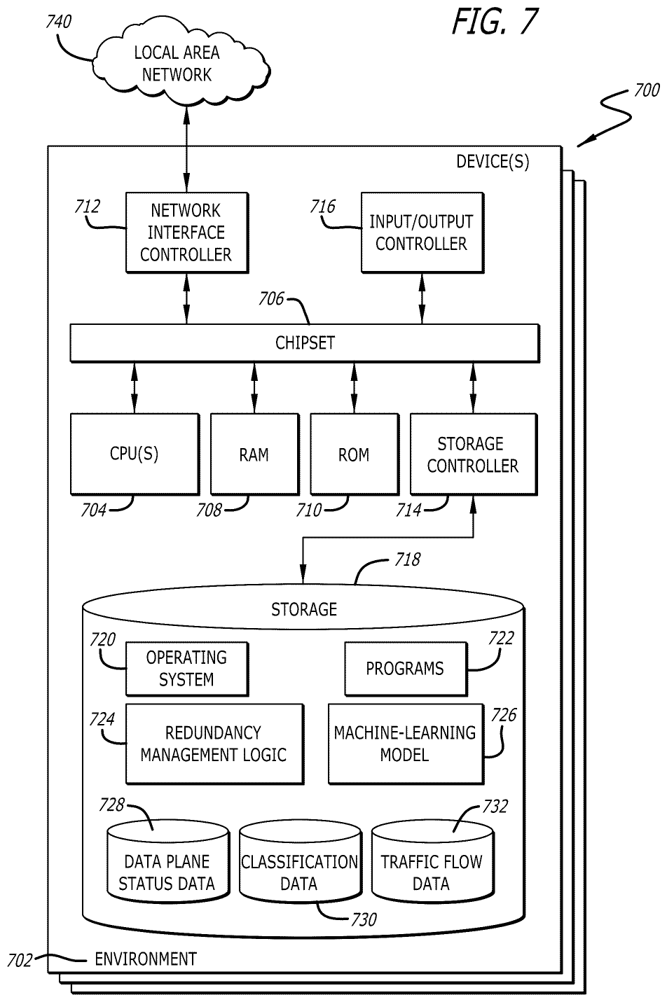

Referring to FIG. 7, a conceptual block diagram for one or more devices 700 capable of executing components and logic for implementing the functionality and embodiments described above is shown. The embodiment of the conceptual block diagram depicted in FIG. 7 can illustrate a conventional server computer, workstation, desktop computer, laptop, tablet, network appliance, e-reader, smartphone, or other computing device, and can be utilized to execute any of the application and/or logic components presented herein. The device 700 may, in some examples, correspond to physical devices or to virtual resources described herein.

In many embodiments, the device 700 may include an environment 702 such as a baseboard or “motherboard,” in physical embodiments that can be configured as a printed circuit board with a multitude of components or devices connected by way of a system bus or other electrical communication paths. Conceptually, in virtualized embodiments, the environment 602 may be a virtual environment that encompasses and executes the remaining components and resources of the device 700. In more embodiments, one or more processors 704, such as, but not limited to, central processing units (“CPUs”) can be configured to operate in conjunction with a chipset 706. The processor(s) 704 can be standard programmable CPUs that perform arithmetic and logical operations necessary for the operation of the device 700.

In additional embodiments, the processor(s) 704 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 706 may provide an interface between the processor(s) 704 and the remainder of the components and devices within the environment 702. The chipset 706 can provide an interface to a random-access memory (“RAM”) 708, which can be used as the main memory in the device 700 in some embodiments. The chipset 707 can further be configured to provide an interface to a computer-readable storage medium such as a read-only memory (“ROM”) 710 or non-volatile RAM (“NVRAM”) 708 for storing basic routines that can help with various tasks such as, but not limited to, starting up the device 700 and/or transferring information between the various components and devices. The ROM 710 or NVRAM 708 can also store other application components necessary for the operation of the device 700 in accordance with various embodiments described herein.

Different embodiments of the device 700 can be configured to operate in a networked environment using logical connections to remote computing devices and computer systems through a network, such as the network 740. The chipset 706 can include functionality for providing network connectivity through a network interface card (“NIC”) 712, which may comprise a gigabit Ethernet adapter or similar component. The NIC 712 can be capable of connecting the device 700 to other devices over the network 740. It is contemplated that multiple NICs 712 may be present in the device 700, connecting the device to other types of networks and remote systems.

In further embodiments, the device 700 can be connected to a storage 718 that provides non-volatile storage for data accessible by the device 700. The storage 718 can, for example, store an operating system 720, applications 722, and data 728, 730, 732, which are described in greater detail below. The storage 718 can be connected to the environment 702 through a storage controller 714 connected to the chipset 707. In certain embodiments, the storage 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 700 can store data within the storage 718 by transforming the physical state of the physical storage units to reflect the information being stored. The specific transformation of physical state can depend on various factors. Examples of such factors can include, but are not limited to, the technology used to implement the physical storage units, whether the storage 718 is characterized as primary or secondary storage, and the like.

For example, the device 700 can store information within the storage 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 700 can further read or access information from the storage 718 by detecting the physical states or characteristics of one or more particular locations within the physical storage units.

In addition to the storage 718 described above, the device 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 700. In some examples, the operations performed by a cloud computing network, and or any components included therein, may be supported by one or more devices similar to device 700. Stated otherwise, some or all of the operations performed by the cloud computing network, and or any components included therein, may be performed by one or more devices 700 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 718 can store an operating system 720 utilized to control the operation of the device 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 718 can store other system or application programs and data utilized by the device 700.

In various embodiment, the storage 718 or other computer-readable storage media is encoded with computer-executable instructions which, when loaded into the device 700, may transform it from a general-purpose computing system into a special-purpose computer capable of implementing the embodiments described herein. These computer-executable instructions may be stored as application 722 and transform the device 700 by specifying how the processor(s) 704 can transition between states, as described above. In some embodiments, the device 700 has access to computer-readable storage media storing computer-executable instructions which, when executed by the device 700, perform the various processes described above with regard to FIGS. 1-6. In more embodiments, the device 700 can also include computer-readable storage media having instructions stored thereupon for performing any of the other computer-implemented operations described herein.

In still further embodiments, the device 700 can also include one or more input/output controllers 716 for receiving and processing input from a number of input devices, such as a keyboard, a mouse, a touchpad, a touch screen, an electronic stylus, or other type of input device. Similarly, an input/output controller 716 can be configured to provide output to a display, such as a computer monitor, a flat panel display, a digital projector, a printer, or other type of output device. Those skilled in the art will recognize that the device 700 might not include all of the components shown in FIG. 7, and can include other components that are not explicitly shown in FIG. 7, or might utilize an architecture completely different than that shown in FIG. 7.

As described above, the device 700 may support a virtualization layer, such as one or more virtual resources executing on the device 700. In some examples, the virtualization layer may be supported by a hypervisor that provides one or more virtual machines running on the device 700 to perform functions described herein. The virtualization layer may generally support a virtual resource that performs at least a portion of the techniques described herein.

In many embodiments, the device 700 can include a redundancy management logic 724 that can be configured to perform one or more of the various steps, processes, operations, and/or other methods that are described above. Often, the redundancy management logic 724 can be a set of instructions stored within a non-volatile memory that, when executed by the processor(s)/controller(s) 704 can carry out these steps, etc. In some embodiments, the redundancy management logic 724 may be a client application that resides on a network-connected device, such as, but not limited to, a server, switch, a router, personal or mobile computing device, an access point (AP). In certain embodiments, the redundancy management logic 724 can enable data plane redundancy in a network device by enabling a quick switchover to a standby data plane in case of a failure of an active data plane.

In several embodiments, the redundancy management logic 724 can enable the device 700 (for example, a router) to provide an optimized data plane redundancy management with one or more intelligent linecards. In other words, the redundancy management logic 724 can enable the linecards to selectively transmit only control traffic or high priority traffic and a small sample of data traffic to a standby data plane. This ensures a considerable reduction of traffic load on the standby data plane while maintaining all the key functions for the standby data plane to provide failure management.

In a number of embodiments, the storage 718 can include data plane status data 728. In some embodiments, the data plane status data 728 may include information on whether a data plane is operating in a normal mode or a failure management mode. In a variety of embodiments, the data plane status data 728 may receive information regarding the operating status of a data plane from a control panel of the device 700. In still other embodiments, the data plane status data 728 may receive information regarding a failure of a data plane from a fault detection and management subsystem of the device 700.

In various embodiments, the storage 718 can include classification data 730. The classification data 730 can comprise criteria based on which a first set of packets of a plurality of packets of a traffic stream is classified into the first category and a remaining second set of packets of the plurality of packets of the traffic stream is classified into the second category. In numerous embodiments, the first category can be associated with a higher priority as compared to the second category. In still numerous embodiments, the first category may be associated with control packets, for example, OAM packets, or the like. Similarly, the second category may be associated with data packets that carry user data traffic.

In still more embodiments, the storage 718 can include traffic flow data 732. Traffic flow data 732 may comprise information regarding the physical connectivity of the device 700, in the form of one or more ports or interfaces to interface with various network media types, for example, Ethernet, Fast Ethernet, Gigabit Ethernet, fiber-optic, serial connections, or the like. In further embodiments, the traffic flow data 732 may provide routing of a packet from an ingress port to an egress port based on the forwarding decisions of an active data plane.

Finally, in many embodiments, data may be processed into a format usable by a machine-learning model 726 (e.g., feature vectors), and or other pre-processing techniques. The machine-learning (“ML”) model 726 may be any type of ML model, such as supervised models, reinforcement models, and/or unsupervised models. The ML model 726 may include one or more of linear regression models, logistic regression models, decision trees, Naïve Bayes models, neural networks, k-means cluster models, random forest models, and/or other types of ML models 726. The ML model 726 may be configured to learn roaming pattern of user devices and generate prediction as to when a user device would roam and what would be a potential trajectory of the moving user device. In some embodiments, a predictive roaming logic may be implemented by utilizing the ML model 726.

The ML model(s) 726 can be configured to generate inferences to make predictions or draw conclusions from data. An inference can be considered the output of a process of applying a model to new data. This can occur by learning from infrastructure data, sustainability data, and/or health data and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 726 may be generated by human/administrator verifications or may compare predicted outcomes with actual outcomes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

1. A device, comprising:
a processor;
a network interface controller configured to provide access to a network; and
a memory communicatively coupled to the processor, wherein the memory comprises a redundancy management logic that is configured to:
classify a plurality of packets into at least a first category or a second category;
transmit a first set of packets of the classified plurality of packets to a first data plane and a second data plane, wherein the second data plane is maintained in a hot standby state;
sample a second set of packets of the classified plurality of packets based on a sampling rate; and
transmit the second set of packets to the first data plane and the sampled second set of packets to the second data plane.

2. The device of claim 1, wherein the first set of packets is classified into the first category.

3. The device of claim 2, wherein the first set of packets is classified into the first category in response to a determination that the first set of packets are control packets.

4. The device of claim 1, wherein the second set of packets is classified into the second category.

5. The device of claim 4, wherein the second set of packets is classified into the second category in response to a determination that the second set of packets are data packets.

6. The device of claim 1, wherein the plurality of packets are packets received by the device.

7. The device of claim 1, wherein the plurality of packets is associated with a traffic stream.

8. The device of claim 1, wherein the first data plane is an active data plane, and the second data plane is a standby data plane.

9. The device of claim 1, wherein a dynamic state of an Operations, Administration, and Maintenance (OAM) protocol is maintained in the second data plane based on the first set of packets.

10. The device of claim 1, wherein at least one packet of the plurality of packets is classified into one of the first category or the second category based on at least one of: an Internet Protocol precedence value, differentiated services code point (DSCP) value, or a class of service (CoS) value associated with the packet.

11. The device of claim 1, wherein at least one packet of the plurality of packets is classified into one of the first category or the second category based on a Media Access Control (MAC) address associated with the at least one packet.

12. The device of claim 1, wherein to transmit the first set of packets to the second data plane, the redundancy management logic is further configured to:
replicate the first set of packets of the classified plurality of packets; and
transmit the replicated first set of packets to the second data plane.

13. The device of claim 1, wherein to sample the second set of packets, the redundancy management logic is further configured to:
replicate the second set of packets of the classified plurality of packets; and
sample the replicated second set of packets based on the sampling rate.

14. The device of claim 1, wherein the redundancy management logic is further configured to perform packet forwarding.

15. The device of claim 14, wherein to perform the packet forwarding, the redundancy management logic is further configured to:
receive a first set of processed packets from the first data plane and a second set of processed packets from the second data plane;
discard the second set of processed packets; and
forward the first set of processed packets to one or more corresponding destinations.

16. The device of claim 15, wherein to perform the packet forwarding, the redundancy management logic is further configured to:
transmit, to the second data plane, the second set of packets based on a failure in the first data plane;
receive a set of processed packets from the second data plane; and
forward the set of processed packets received from the second data plane to one or more corresponding destinations.

17. A device, comprising:
a plurality of data planes, comprising at least a first data plane and a second data plane;
a processor;
a network interface controller configured to provide access to a network; and
a memory communicatively coupled to the processor, wherein the memory comprises a redundancy management logic that is configured to:
classify a plurality of packets into at least a first category or a second category;
transmit a first set of packets of the classified plurality of packets to the first data plane and the second data plane, wherein the second data plane is maintained in a hot standby state;
sample a second set of packets of the classified plurality of packets based on a sampling rate; and
transmit the second set of packets to the first data plane and the sampled second set of packets to the second data plane.

18. The device of claim 17, wherein the first data plane is an active data plane and the second data plane is a standby data plane.

19. The device of claim 18, wherein the second data plane is configured to operate as the active data plane based on a failure of the first data plane, and wherein the redundancy management logic is further configured to transmit the second set of packets to the second data plane.

20. A method comprising:
classifying a plurality of packets into at least a first category or a second category;
transmitting a first set of packets of the classified plurality of packets to a first data plane and a second data plane, wherein the second data plane is maintained in a hot standby state;
sampling a second set of packets of the classified plurality of packets based on a sampling rate; and
transmitting the second set of packets to the first data plane and the sampled second set of packets to the second data plane.
